(19) United States
(12) Patent Application Publication
(10) Pub. No.: US 2016/0195039 A1
(43) Pub. Date: Jul. 7, 2016

(54) DEVICE FOR FEEDING A ROCKET ENGINE WITH PROPELLANT

(71) Applicant: SNECMA, Paris (FR)

(72) Inventors: François DANGUY, Tourny (FR); Alban LEMAITRE, Athis-mons (FR); Laurent FABBRI, Gasny (FR); Vincent PENDARIES, Heubecourt-haricourt (FR)

(73) Assignee: SNECMA, Paris (FR)

(21) Appl. No.: 14/909,920

(22) PCT Filed: Aug. 4, 2014
(86) PCT No.: PCT/FR2014/052025

§ 371 Date: Feb. 3, 2016

(30) Foreign Application Priority Data
Aug. 6, 2013 (FR) 1357810

(51) Int. Cl. F02K 9/46

(52) U.S. Cl. CPC F02K 9/46

(57) ABSTRACT

A device (10A, 10B) for feeding a rocket engine with propellant, the device comprising at least one propellant tank (10, 11), a combustion chamber (18), and a feed pipe (12, 13) extending from the tank (10, 11) to the combustion chamber (18) to feed propellant to the combustion chamber. A valve (14, 15) and a main pump (16, 17) are arranged in succession along the feed pipe. The rocket engine device further comprises at least one branch pump (20, 21, 120, 220) making a branch connection to the tank upstream from the valve in order to feed an auxiliary pipe (22, 23, 122, 222) that serves an auxiliary function of the rocket engine.

### FIELD OF THE INVENTION

The present invention relates to a device for feeding a rocket engine with propellant and also to a rocket engine fitted with such a propellant feed device.

### STATE OF THE PRIOR ART

A known rocket engine propellant feed device comprises at least one propellant tank, a combustion chamber, and a feed pipe extending from the tank to the combustion chamber in order to feed propellant to the combustion chamber and having a valve and a main pump arranged in succession along the feed pipe.

In that known feed device, it is not easy to take off any propellant effectively for purposes other than the main feed to the combustion chamber and to do so without significantly penalizing the performance of the rocket engine. There thus exists a need on these lines.

### SUMMARY OF THE INVENTION

In an embodiment, the rocket engine device of the invention comprises at least one propellant tank, a combustion chamber, a feed pipe extending from the tank to the combustion chamber to feed propellant to the combustion chamber with propellant and having a valve and a main pump arranged in succession along the feed pipe, and at least one branch pump connected by a branch to the tank upstream from the valve in order to feed an auxiliary pipe that serves an auxiliary function of the rocket engine.

The terms “upstream” and “downstream” are defined relative to the normal flow direction of a propellant in a feed circuit, in particular in the direction going from the tank to the combustion chamber.

It can be understood that the branch pump is in fluid flow connection with the tank upstream from the valve, either directly with the tank or else via the portion of feed pipe that extends between the tank and the valve.

It can also be understood that the feed device has one or more propellant tanks, each tank being connected to the combustion chamber via a feed pipe that is distinct from the feed pipe of one or more other tanks, each of these pipes having its own valve arranged upstream from a main pump. In the meaning of the invention, at least one branch pump is provided that is arranged upstream from a valve in a feed pipe. For example, there may be two branch pumps arranged upstream from a first valve, a single branch pump arranged upstream from a second valve, and no branch pump upstream from a third valve. In another example, there is only one branch pump and it is arranged upstream from each of the valves. In yet another example, there is only one branch pump and it is arranged upstream from a single one of the valves.

The valve makes it possible to interrupt or to authorize the feeding of propellant to the combustion chamber. Since the branch pump is connected to the tank upstream from the valve, it can be understood that the propellant from the tank can be taken off by the branch pump prior to passing through the valve. Thus, as a result of this advantageous arrangement of the branch pump within the feed device, it is possible to take off propellant in order to feed the auxiliary pipe regardless of the open or closed state of the valve. Furthermore, this makes it possible for the branch pump to operate at a very large sub-rate while minimizing any risk of operating instability and providing good suction capacity over a wide operating range.

Furthermore, since the branch pump is constantly in contact with the propellant of the tank or with propellant in the proximity of the tank and contained in the feed pipe portion extending between the tank and the valve, the branch pump is at a temperature substantially equal to the temperature of said propellant, which is a prior condition for being able to pump propellant. The term “substantially equal temperature” is used to mean temperatures that differ by a few kelvins, e.g. depending on the type of propellant, by no more than 10 kelvins. This makes it possible to minimize the time required for starting such a branch pump and this enables it to be permanently available.

In addition, because of the position of the branch pump, the structure of the feed device is relatively simple and its overall size is small.

In certain embodiments, the branch pump is an electric pump having a motor comprising a rotor and a stator, the rotor being arranged in a rotor chamber from which the stator is hermetically isolated.

In the meaning of the invention, the branch pump comprises a motor portion or “motor”, and a pump portion. By way of example, the pump portion may comprise a volute and an impeller. The motor portion comprises everything that does not form part of the pump portion. Propellant (or some other fluid) can flow along the rotor, in the rotor chamber. In contrast, because of the hermetic isolation, the propellant cannot reach the stator. Since the stator, which includes in particular a portion with a winding, is isolated from the propellant, the branch pump does not require any other special sealing other than conventional casing gaskets, thereby simplifying its design and improving its reliability. Furthermore, because of this pump structure, the branch pump can be used equally well in a reducing medium (fuel) and in an oxidizing medium (oxidizer). There is no physical contact between the propellant and the electrical power supply of the pump, thus making it possible in particular to use the pump in an oxidizing medium.

In certain embodiments, the motor is of the permanent magnet type. For example, a plurality of permanent magnets are secured to the rotor. These magnets are held on the rotor by a band or an insulating layer, or indeed by other known means. The band may be made of metal and it may be bonded to the rotor, thereby isolating the magnets from the propellant. In a variant, if the magnets are not compatible with the propellant, they may be fastened by other means, e.g. by means of a band that is not bonded to the rotor.

In certain embodiments, an electrical power supply for a stator of the branch pump is directly accessible from outside the tank and outside the feed pipe.

It can thus be understood that none of the electrical power supply connections of the branch pump come into contact with the propellant. This makes it possible to avoid any constricting measure for sealing the electrical power supply, and in particular for electrical connectors. This makes it possible to use conventional components, thereby simplifying the design and the making of the pump, in particular its electrical portion, and optimizing its size and weight while reducing costs.

In certain embodiments, the rotor is supported by at least one bearing that is cooled by a cooling circuit using the propellant as cooling fluid.

For example, the bearing may be of the fluid bearing type and/or it may comprise a ball bearing and/or it may comprise a roller bearing. The propellant flowing as cooling fluid can then be reinjected into the pump portion (e.g. into the volute) of said branch pump, into the tank, or into the feed pipe. Such cooling of one or more bearings contributes to evacuating the power dissipated by the bearings and by the motor, and to keeping the branch pump at the same temperature as the propellant.

In certain embodiments, the rotor is supported by two bearings. For example, each of the two bearings is cooled by a cooling circuit using the propellant as cooling fluid. In another embodiment, both bearings are cooled by a single cooling circuit using the propellant as cooling fluid.

In certain embodiments, an inlet of the cooling circuit within the branch pump is provided beside one of the two bearings, and an outlet of the cooling circuit is provided beside the other one of the two bearings. For example, the cooling fluid may flow along the rotor going from the inlet to the outlet.

In certain embodiments, the branch pump has a motor casing, said motor casing having a cooling surface along which the propellant can flow as a cooling fluid.

The term “motor casing” is used to designate a stationary structure providing support and external protection to the stationary and moving elements of the branch pump, and in particular its motor.

It can be understood that the propellant flows along the cooling surface, in contact with said surface, and cools said surface by convection. Such cooling of the motor casing contributes to keeping the branch pump at the same temperature as the propellant. Naturally, the cooling circuit of the motor casing may be in fluid flow connection with the cooling circuit of the bearing(s).

By way of example, the motor casing presents a double wall defining a space within which the propellant can flow as cooling fluid.

In certain embodiments, the branch pump is fastened to a wall of one element selected from the tank and the feed pipe.

The branch pump is thus in direct contact with the propellant contained in the tank, or in the proximity of the tank in the feed pipe portion extending between the tank and the valve, thereby ensuring that it is kept cold (i.e. substantially at the same temperature as the propellant) with great reliability and negligible impact on the temperature of the propellant in the tank or in the feed pipe, given the quantity of propellant that is present. Furthermore, such fastening makes it possible to optimize the space occupied by the pump within the feed pipe.

When the rocket engine device has a plurality of tanks and a plurality of branch pumps, there is no need for all of the branch pumps to be connected to the tanks and/or the pipes in the same way. For example, if a rocket engine device has one tank containing an oxidizer propellant and another tank containing a fuel propellant, each tank being provided with a respective combustion chamber feed pipe, then a branch pump may be fastened to a wall of each tank, or to a wall of each feed pipe, or indeed one branch pump may be fastened to a wall of the oxidizer propellant tank and another branch pump may be fastened to a wall of the fuel propellant feed pipe, or vice versa.

When the branch pump is fastened on a wall of the propellant tank, it is advantageously fastened on a bottom wall of said propellant tank. The term “bottom” is defined relative to the axis and the direction of the acceleration to which the rocket engine propellant feed device is subjected while the rocket engine is in operation. A bottom wall is thus a wall placed at the opposite end relative to the direction of the acceleration generated by the rocket engine. Since the branch pump is at the bottom of the tank, propellant is always available in satisfactory manner for feeding the branch pump.

In certain embodiments, the branch pump includes a fluid delivery volute and a motor casing, said volute being fastened to the motor casing and the motor casing being fastened to said wall.

A fluid delivery volute, or more generally a volute, is a part that may optionally be made up of several portions, and of a shape that is designed to convey the propellant from the inlet of the pumping circuit to the outlet of the pumping circuit of the branch pump. An impeller that serves to pump the fluid is housed in the volute.

In a first variant, the motor casing is located at least in part inside the element selected from the tank and the feed pipe having the branch pump fastened to its wall, while the volute is outside said element.

The overall size of the branch pump is thus limited and it is possible to incorporate the pump within the feed device from the outside of the tank/pipe. Mounting in this way provides an advantageous balance between the overall size of the pump within the feed device and ease of access to the pump. In addition, such mounting serves to minimize mechanical stresses on the fastener portion, generally a flange, fastening the pump to the tank or the pipe.

In a second variant, the motor casing and the volute are outside the element selected from the tank and the feed pipe having the branch pump fastened to its wall.

Incorporating the branch pump within the feed device is particularly easy and the performance of the branch pump is optimized.

In a third variant, the engine casing and the volute are inside the element selected from the tank and the feed pipe having the branch pump fastened on its wall.

The overall size of the pump is reduced to the greatest possible extent. Furthermore, the outside wall of the motor casing and of the volute is directly in contact with the propellant, thereby optimizing cooling of the branch pump, and thus its availability.

The invention also provides a rocket engine including a rocket engine propellant feed device of the invention.

### BRIEF DESCRIPTION OF THE DRAWINGS

The invention can be well understood and its advantages appear better on reading the following detailed description of embodiments given as non-limiting examples. The description refers to the accompanying sheets of figures, on which:

FIGS. 1A and 1B are diagrammatic views of a rocket engine of the invention;

FIG. 2 is a longitudinal section view of the branch pump of FIG. 1A or 1B;

FIG. 3 is a longitudinal section view of a second embodiment of the branch pump; and

FIG. 4 is a longitudinal section view of a third embodiment of the branch pump.

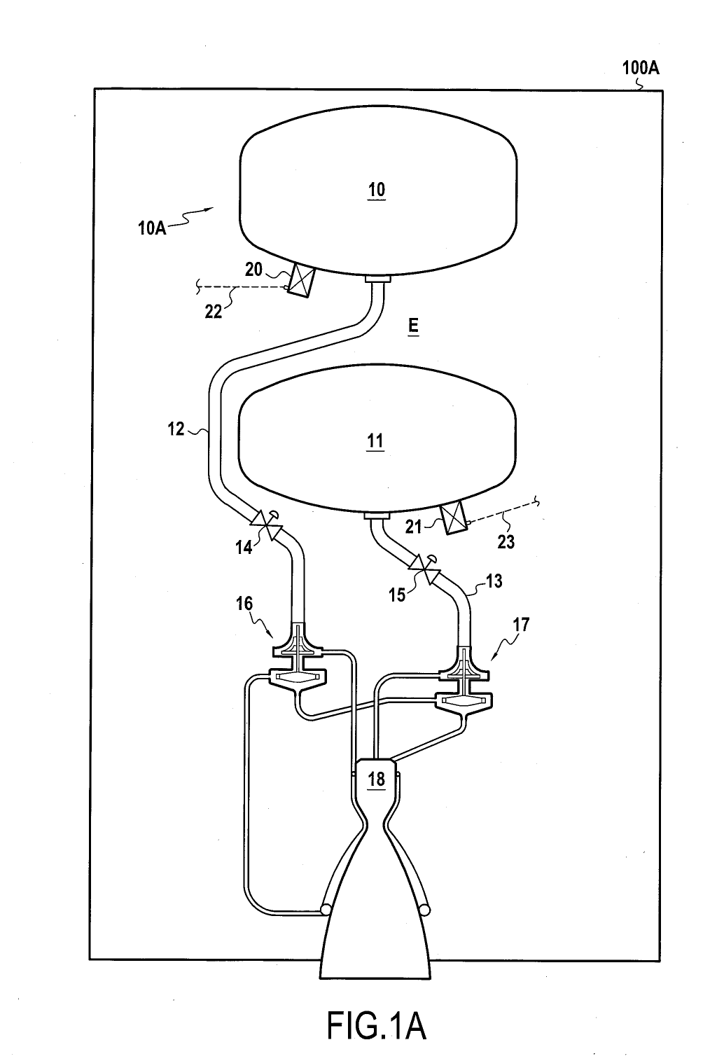

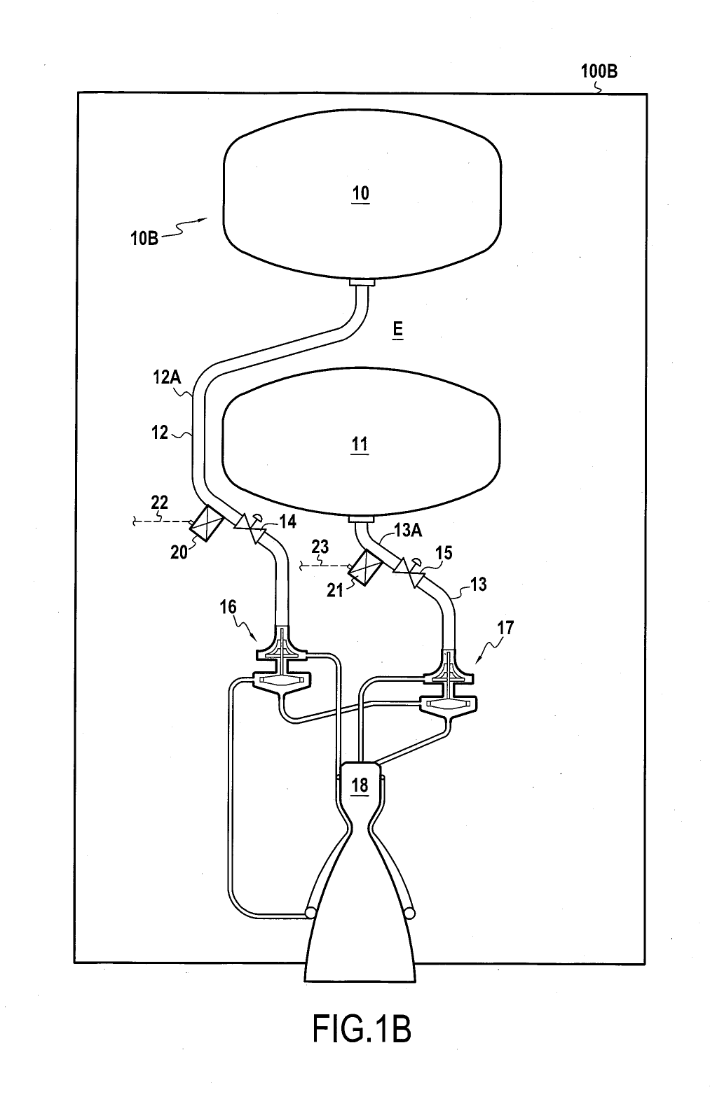

FIG. 1A is a diagrammatic view of a rocket engine 100A having a propellant feed device 10A. The propellant feed device 10A comprises a first tank 10, e.g. containing a fuel propellant, e.g. liquid hydrogen, and a second tank 11, e.g. containing an oxidizer propellant, e.g. liquid oxygen. The first tank 10 feeds a combustion chamber 18 with propellant via a first feed pipe 12 having arranged in succession thereon from upstream to downstream: a first valve 14 and a first main pump 16. The second tank 11 feeds propellant to the combustion chamber 18 via a second feed pipe 13 having arranged in succession thereon, from upstream to downstream: a second valve 15 and a second main pump 17. In this example, the main pumps 16 and 17 are turbopumps. Prior to being injected into the combustion chamber 18, the propellant pumped by the first pump 16 passes through a heat exchanger to exchange heat with the combustion chamber 18, and then, once heated, it drives the turbines of the turbopumps 16 and 17 (i.e. the rocket engine has an expander cycle). The rocket engine device could form part of a rocket engine of some other type, e.g. with integrated flow (a staged combustion cycle) or with branch flow (cycle with or without a gas generator).

A first branch pump 20 is fastened to a bottom wall of the first tank 10 and feeds a first auxiliary pipe 22. The first branch pump 20 is thus connected by a branch to the first tank 10, i.e. the propellant that passes via the first branch pump 20 is sent to the first auxiliary pipe 22 and not to the first feed pipe 12. Likewise, a second branch pump 21 is fastened to a bottom wall of the second tank 11 and feeds a second auxiliary pipe 23. The second branch pump 21 is thus connected by a branch to the second tank 11, i.e. the propellant that passes via the second branch pump 21 is sent to the second auxiliary pipe 23 and not to the second feed pipe 13.

As can be seen in FIG. 1B, in another example, within the propellant feed device 10B of the rocket engine 100B, the branch pumps 20 and 21 are not fastened to the bottom walls of the tanks 10 and 11, but are fastened respectively to a wall of the first feed pipe 12, upstream from the first valve 14, and to a wall of the second feed pipe 13, upstream from the second valve 15. In this way, the branch pumps 20 and 21 are connected respectively to the tanks 10 and 11 upstream from the valves 14 and 15 via feed pipe portions 12A and 13A that extend respectively between the tanks 10, 11 and the valves 14, 15.

In addition, in other embodiments that are not shown, the first branch pump 20 could be fastened to the first tank 10 while the second branch pump 21 could be fastened to the second feed pipe 13, or indeed the first branch pump 20 could be fastened to the first feed pipe 12 while the second branch pump 21 is fastened to the second tank 11. Under all circumstances, the branch pumps 20 and 21 are connected to the respective tanks 10 and 11 upstream from the respective valves 14 and 15. Naturally, the device 10A or 10B could have only one branch pump, or it could have more than one branch pump connected to a single tank and/or pipe, or indeed it could have more than one branch pump connected to each tank and/or pipe.

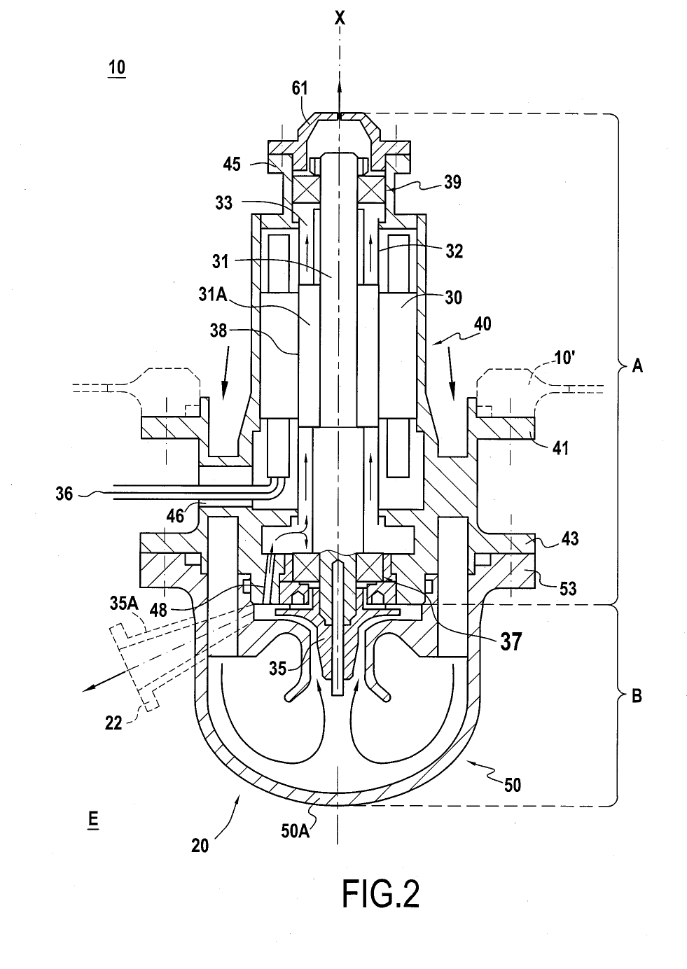

With reference to FIGS. 2 to 4, there follows a detailed description of the structure of the branch pump. The first branch pump 20 fastened to the bottom wall of the first tank 10 is taken by way of example, however the structure described below remains substantially unchanged for the second branch pump 21 and/or if the pump is fastened other than to the bottom wall of the first tank 10, as shown in FIG. 1B by way of example. The arrows in FIGS. 2 to 4 show the flow directions of propellant through the first branch pump.

The terms “top” and “bottom” are defined relative to the axis X of the branch pump, forming the axis of rotation of the rotor, and in the orientation shown in the figures, the top of the pump is arranged at the top of the figure and the bottom of the pump is arranged at the bottom of the figure.

FIG. 2 is a longitudinal section view of the first branch pump 20 fastened to a bottom wall 10′ of the first tank 10. This embodiment corresponds to the first above-mentioned variant. The first branch pump 20 is an electric pump having a motor that comprises a stator 30 and a rotor 31 (including a rotor shaft) that are received in a motor casing 40. The pump 20 also has a fluid delivery volute 50. The motor casing 40 has a first fastener portion 41 for fastening to the wall 10′ of the first tank, and a second fastener portion 43 for fastening to a corresponding fastener portion 53 of the volute. These fasteners are implemented by means known from elsewhere. Thus, the motor casing 40 is fastened to the wall 10′ of the tank and the volute 50 is fastened to the motor casing 40.

The motor casing 40 is located in part inside the first tank 10, while the volute 50 is outside said tank. This makes it possible to provide a pierced arm 46 through the engine casing 40 to pass an electrical power supply cable 36 to the stator 30. The cable 36 is thus easily accessible from the outside E of the first tank 10 and of the first branch pump 20.

The rotor 31 is arranged in a rotor chamber 33 from which the stator is isolated by a separator wall 32. Thus, the stator 30 is hermetically isolated from the propellant flowing through the branch pump within the rotor chamber 33, whereby the electric cable 36 is likewise isolated from the rotor chamber 33 and thus from the propellant.

The motor of the branch pump 20 is of the permanent magnet type.

An impeller 35 for performing pumping is coupled to rotate with the rotor 31. The rotor 31 is supported by a first bearing 37 and by a second bearing 39. In general manner, the portion A forms the motor portion or “motor”, while the portion B forms the pump portion of the branch pump 20.

After passing through the impeller 35, most of the propellant is sent to the first auxiliary pipe 22 via the discharge tube 35A. Nevertheless, a passage 48 enables a fraction of the pumped propellant to be taken off upstream from the tube 35A in order to cool the bearings 37 and 39. This propellant fraction flows in part through the first bearing 37 prior to being reinjected into the volute. The remainder of the propellant that has been taken off flows along the separation wall 32 forming a cooling surface, and flows in particular through the airgap 38 that exists between the wall 32 level with the stator 30 and the magnets 31A of the rotor 31, and then reaches the second bearing 39. This propellant that has been taken off is then reinjected into the first tank 10 via an ejection nozzle 61.

In a variant, the passage 48 is not provided, and the first bearing 37, the wall 32, and the second bearing 39 are cooled in series by the propellant taken off upstream from the tube 35A.

In the embodiment of FIG. 2, the fluid delivery volute 50 presents an external casing 50A that is generally in the shape of a pot. The portion 53 for fastening the volute 50 to the motor casing 40 is at the periphery of the pot 50A, at the top of the pot.

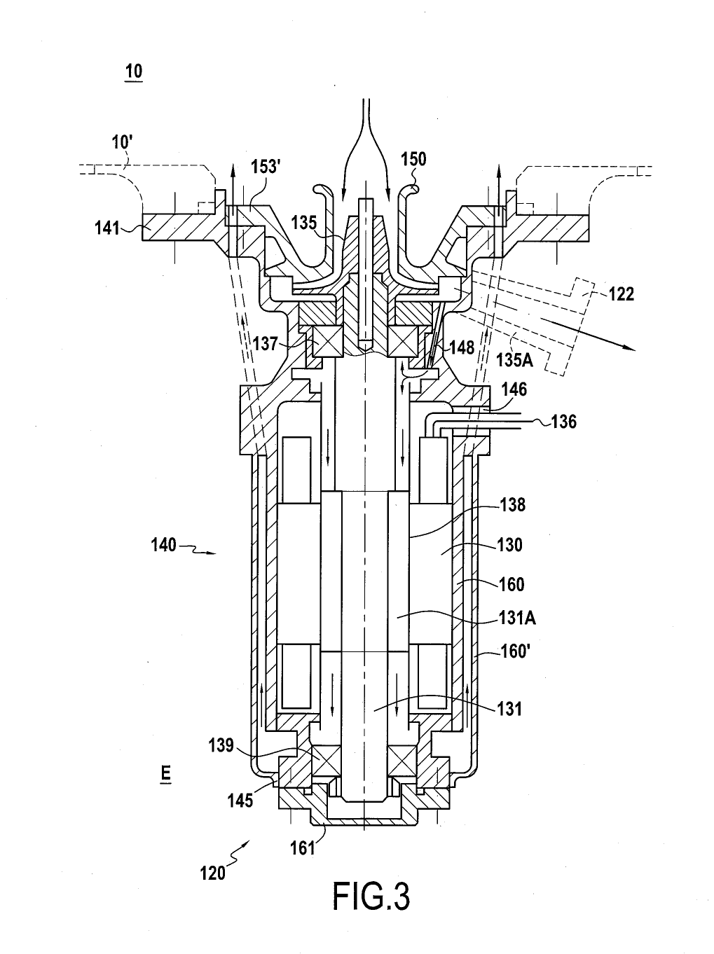

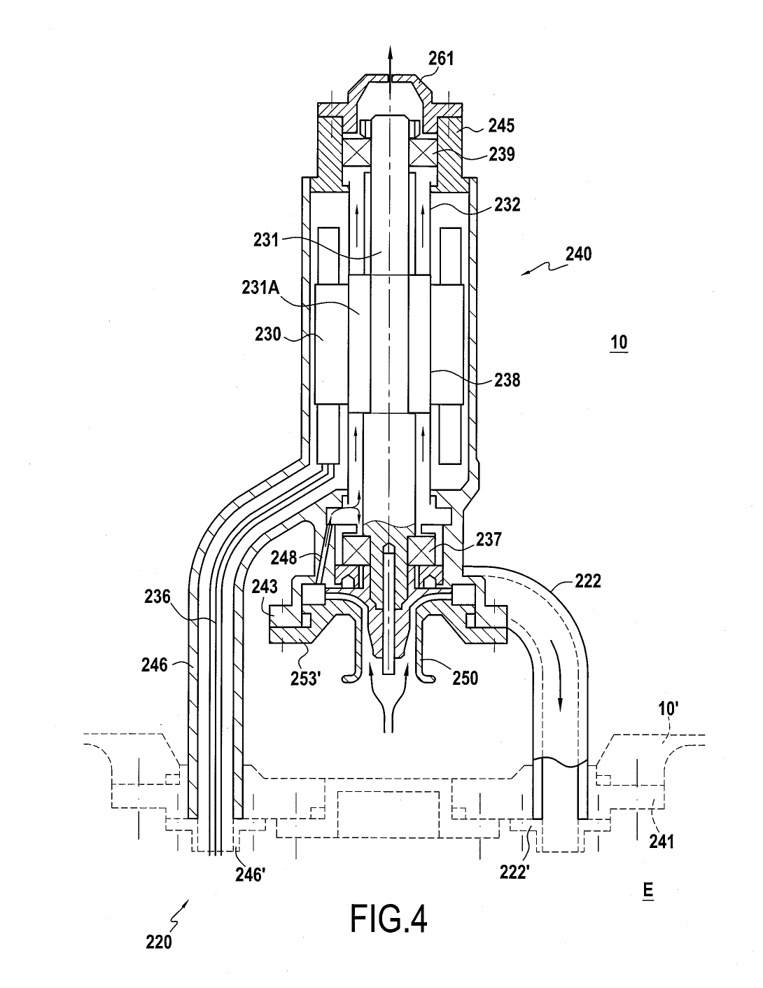

FIGS. 3 and 4 show other embodiments of the branch pump corresponding respectively to the second and third above-mentioned variants. In these figures, elements corresponding or identical to elements of the first embodiment are given the same reference signs, except for the hundreds digit, and they are not described again.

In the embodiment of FIG. 3, the engine casing 140 and the fluid delivery volute 150 of the first branch pump 120 are placed outside the first tank 10, i.e. they project into the outside E from the wall 10′. The fluid delivery volute 150 does not have an outside casing forming a pot insofar as it is arranged directly inside the first tank 10.

Instead of the ejection nozzle 61 of the branch pump 20, the branch pump 120 has a cup 161 without any hole for passing propellant. The cup 161 is fastened to the engine casing 140 via a portion 145 for fastening to the engine casing.

In this embodiment, the propellant is sucked in from the top directly from the first tank 10. The propellant fraction that is used for cooling is taken off via the passage 148 upstream from the tube 135A and then flows as described above via the first bearing 137 and the second bearing 139. Thereafter, the propellant fraction that has been used for cooling the wall 132 and the second bearing 139 is directed into an inside space arranged at the outer periphery of the engine casing 140 between two walls 160 and 160′. The walls 132, 160, and 160′ form cooling surface along which the propellant can flow prior to being reinjected into the first tank 10, around the volute 150. Propellant is thus sucked in and cooling propellant is thus rejected at the same end of the branch pump 120, and in particular beside its first bearing 137. Naturally, as above, in a variant, the passage 148 is not provided and the first bearing 137, the wall 132, and the second bearing 139 are cooled in series by the propellant taken from within the volute.

In this embodiment, the positioning of the motor casing 140 outside the first tank 10 ensures there is always particularly easy access to the electrical power supply cable 136 for the stator 130 via a pierced arm 146 that opens to the outside E of the tank 10 and of the auxiliary pipe 122.

FIG. 4 shows a third embodiment of the branch pump 220, in which the motor casing 240 and the fluid delivery volute 250 are arranged inside the first tank 10. The volute 250 faces the bottom wall 10′ of the first tank. The engine casing 240 is fastened to the wall 10′ of said tank 10 by means of the auxiliary pipe 222, via a fastening 222′, and by a pierced arm 246 of the engine casing 240 via a fastening 246′. The arm 246 is a hollow arm for providing an electrical connection to the stator 230 from the outside E. The fastening 222′ of the auxiliary pipe and the fastening 246′ of the arm may be any type of fastening known from elsewhere.

Like the first branch pump 120 of the second embodiment, the first branch pump 220 in the third embodiment is arranged so that the volute 250 is placed directly inside the first tank 10.

In the embodiment shown in FIG. 4, the propellant is sucked in from the bottom. The major portion of the propellant is sent to the auxiliary pipe 222, while a fraction is taken off for cooling the bearings 237 and 239. This propellant fraction is taken off via the passage 248 and flows firstly through the first bearing 237 and secondly through the second bearing 239, as described above. Likewise, in a variant, the passage 248 is not provided and the first bearing 237, the wall 232, and the second bearing 239 are cooled in series by the propellant taken off from within the volute.

Although, the present invention is described with reference to specific embodiments, it is clear that modifications and changes may be made to those embodiments without going beyond the general scope of the invention as defined by the claims. In particular, individual characteristics of the various embodiments shown and/or described may be combined in additional embodiments. Consequently, the description and the drawings should be considered in a sense that is illustrative rather than restrictive.

1. A device for feeding a rocket engine with propellant, the device comprising at least one propellant tank, a combustion chamber, and a feed pipe extending from the tank to the combustion chamber to feed propellant to the combustion chamber with propellant and having a valve and a main pump arranged in succession along the feed pipe, the device comprising at least one branch pump connected by a branch to the tank upstream from the valve in order to feed an auxiliary pipe that serves an auxiliary function of the rocket engine.

2. A device according to claim 1, wherein the branch pump is an electric pump having a motor comprising a rotor and a stator, the rotor being arranged in a rotor chamber from which the stator is hermetically isolated.

3. A device according to claim 1, wherein an electrical power supply for a stator of the branch pump is directly accessible from outside the tank and outside the feed pipe.

4. A device according to claim 1, wherein the rotor is supported by at least one bearing that is cooled by a cooling circuit using the propellant as cooling fluid.

5. A device according to claim 1, wherein the branch pump has a motor casing, said motor casing having a surface along which the propellant can flow as a cooling fluid.

6. A device according to claim 1, wherein the branch pump is fastened to a wall of one element selected from the tank and the feed pipe.

7. A device according to claim 6, wherein the branch pump includes a fluid delivery volute and a motor casing, said volute being fastened to the motor casing and the motor casing being fastened to said wall.

8. A device according to claim 7, wherein the motor casing is located at least in part inside the element selected from the tank and the feed pipe having the branch pump fastened to its wall, while the volute is outside said element.

9. A device according to claim 7, wherein the motor casing and the volute are outside the element selected from the tank and the feed pipe having the branch pump fastened to its wall.

10. A device according to claim 7, wherein the engine casing and the volute are inside the element selected from the tank and the feed pipe having the branch pump fastened on its wall.

11. A rocket engine including a propellant feed device according to claim 1.
